(19) United States
(12) Patent Application Publication
(10) Pub. No.: US 2014/0033698 A1
(43) Pub. Date: Feb. 6, 2014

(54) METERLESS HYDRAULIC SYSTEM HAVING FORCE MODULATION

(71) Applicant: Patrick OPDENBOSCH, Peoria, IL (US)

(72) Inventor: Patrick OPDENBOSCH, Peoria, IL (US)

(21) Appl. No.: 13/563,353

(22) Filed: Jul. 31, 2012

(51) Int. Cl. F15B 11/028; F15B 13/042; F16D 31/02

(52) U.S. Cl. 60/422; 60/464; 60/494; 60/327

(57) ABSTRACT

A hydraulic system is disclosed. The hydraulic system may have a pump configured to draw low-pressure fluid from one of a first and a second passage, and discharge fluid at an elevated pressure into the other of the passages. The hydraulic system may also have an actuator coupled to the pump via the first and second passages, a charge circuit, and a makeup valve movable by a pressure differential between the first and second passages to connect the charge circuit with a lower pressure one of the first and second passages. The hydraulic system may further have a first force modulation control valve configured to selectively direct fluid from the pump through the makeup valve to the second passage to bypass the actuator, and a second force modulation control valve configured to selectively direct fluid from the pump through the makeup valve to the first passage to bypass the actuator.

### TECHNICAL FIELD

The present disclosure relates generally to a hydraulic system and, more particularly, to a meterless hydraulic system having force modulation.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed and/or force of each actuator can be independently controlled by selectively throttling (i.e., restricting) a flow of the pressurized fluid from the pump into and/or out of each actuator. For example, to move a particular actuator at a higher speed and/or with a higher force, the flow of fluid from the pump into the actuator is unrestricted or restricted by only a small amount. In contrast, to move the same or another actuator at a lower speed and/or with a lower force, the restriction placed on the flow of fluid is increased. Although adequate for many applications, the use of fluid restriction to control actuator speed or force can result in flow losses that reduce an overall efficiency of the hydraulic system.

An alternative type of hydraulic system is known as a meterless hydraulic system. A meterless hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator with a lower speed, the pump discharges the fluid at a slower rate. A meterless hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and little or no throttling of the fluid flow is required.

An exemplary meterless hydraulic system is disclosed in U.S. Patent Publication 2008/0250783 of Griswold that published on Oct. 16, 2008 (the '783 publication). In the '783 publication, a multi-actuator closed-loop hydraulic system is described. The hydraulic system includes a first circuit having a first actuator connected to a first pump in a closed-loop manner, and a second circuit having a second actuator connected to a second pump in a closed-loop manner. The hydraulic system also includes a third pump connected in an open-loop manner to the first and second circuits to provide additional flow to the first and second circuits.

The closed-loop hydraulic system of the '783 publication described above may be less than optimal. In particular, the system does not disclose a way to modulate a force of the actuators.

The hydraulic system of the present disclosure is directed toward solving one or more of the problems set forth above and/or other problems of the prior art.

### SUMMARY

In one aspect, the present disclosure is directed to a hydraulic system. The hydraulic system may include a pump configured to draw low-pressure fluid from one of a first passage and a second passage, and discharge fluid at an elevated pressure into the other of the first and second passages. The hydraulic system may also include an actuator coupled to the pump via the first and second passages, a charge circuit, and a makeup valve movable by a pressure differential between the first and second passages to connect the charge circuit with a lower pressure one of the first and second passages. The hydraulic system may further include a first force modulation control valve configured to selectively direct fluid from the pump through the makeup valve to the second passage to bypass the actuator, and a second force modulation control valve configured to selectively direct fluid from the pump through the makeup valve to the first passage to bypass the actuator.

In another aspect, the present disclosure is directed to a method of operating a hydraulic system. The method may include drawing fluid from one of a first passage and a second passage fluidly connected to an actuator, pressurizing the fluid with a pump, and directing the pressurized fluid into the other of the first and second passages to move the actuator. The method may further include selectively directing makeup fluid from a charge circuit through a makeup valve into a lower-pressure one of the first and second passages. The method may additionally include selectively directing fluid from the pump through the makeup valve to the second passage to bypass the actuator, and selectively directing fluid from the pump through the makeup valve to the first passage to bypass the actuator.

### BRIEF DESCRIPTION OF THE DRAWINGS

FIG. 1 is a pictorial illustration of an exemplary disclosed machine;

FIG. 2 is a schematic illustration of an exemplary disclosed hydraulic system that may be used in conjunction with the machine of FIG. 1;

FIG. 3 is a schematic illustration of another exemplary disclosed hydraulic system that may be used in conjunction with the machine of FIG. 1; and

FIG. 4 is a schematic illustration of yet another exemplary disclosed hydraulic system that may be used in conjunction with the machine of FIG. 1.

### DETAILED DESCRIPTION

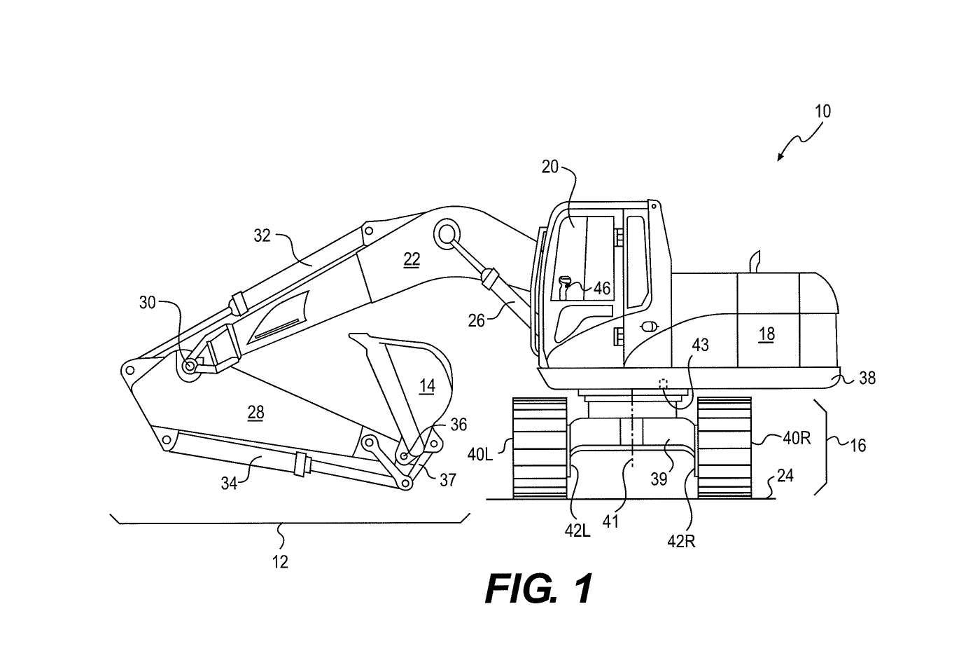

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as the excavator shown in FIG. 1, a dozer, a loader, a backhoe, a motor grader, a dump truck, or any other earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. In the disclosed exemplary embodiment, implement system 12 includes a boom 22 that is vertically pivotal about a horizontal axis (not shown) relative to a work surface 24 by a pair of adjacent, double-acting, hydraulic cylinders 26 (only one shown in FIG. 1). Implement system 12 also includes a stick 28 that is vertically pivotal about a horizontal axis 30 by a single, double-acting, hydraulic cylinder 32, and a single, double-acting, hydraulic cylinder 34 that is operatively connected between stick 28 and work tool 14 to pivot work tool 14 vertically about a horizontal pivot axis 36. Hydraulic cylinder 34 is connected to work tool 14 by way of a power link 37. Boom 22 is pivotally connected to a body 38 of machine 10, and body 38 is pivotally connected to an undercarriage 39 and movable about a vertical axis 41 by a hydraulic swing motor 43. Stick 28 is pivotally connect boom 22 to work tool 14 by way of axis 30 and 36. It is contemplated that implement system 12 may be arranged differently, if desired.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 40L located at one side of machine 10, and a right track 40R located at an opposing side of machine 10. Left track 40L may be driven by a left travel motor 42L, while right track 40R may be driven by a right travel motor 42R. It is contemplated that drive system 16 could alternatively include traction devices other than tracks, such as wheels, belts, or other known traction devices. Machine 10 may be steered by generating a speed and/or rotational direction difference between left and right travel motors 42L, 42R, while straight travel may be facilitated by generating substantially equal output speeds and rotational directions from left and right travel motors 42L, 42R.

Power source 18 may embody an engine such as, for example, a diesel engine, a gasoline engine, a gaseous fuel-powered engine, or any other type of combustion engine known in the art. It is contemplated that, in some applications, power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34, left and right travel motors 42L, 42R, and/or swing motor 43.

Operator station 20 may include devices that receive input from a machine operator indicative of desired machine maneuvering. Specifically, operator station 20 may include one or more interface devices 46, for example a joystick, a steering wheel, and/or a pedal, that are located proximate an operator seat (not shown). Interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

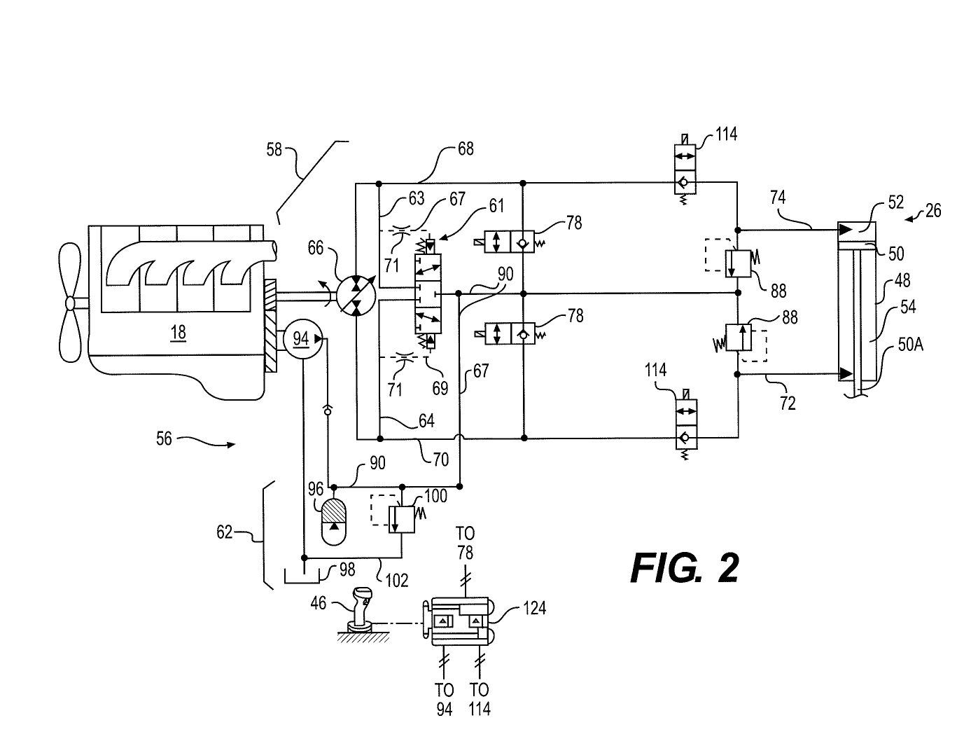

One exemplary linear actuator (one of hydraulic cylinders 26) is shown in the schematic of FIG. 2. It should be noted that, while a specific linear actuator is shown, the depicted actuator may represent any one or more of the linear actuators (e.g., hydraulic cylinders 26, 32, 34) or the rotary actuators (left travel, right travel, or swing motors 42L, 42R, 43) of machine 10.

As shown schematically in FIG. 2, hydraulic cylinder 26 may comprise any type of linear actuator known in the art. Hydraulic cylinder 26 may include a tube 48, and a piston assembly 50 arranged within tube 48 to form a first chamber 52 and an opposing second chamber 54. In one example, a rod portion 50A of piston assembly 50 may extend through an end of second chamber 54. As such, second chamber 54 may be considered the rod-end chamber of hydraulic cylinders 26 and 34, while first chamber 52 may be considered the head-end chamber.

First and second chambers 52, 54 may each be selectively provided with pressurized fluid and drained of the pressurized fluid to cause piston assembly 50 to move within tube 48, thereby changing an effective length of hydraulic cylinder 26 and moving work tool 14 (referring to FIG. 1). A flow rate of fluid into and out of first and second chambers 52, 54 may relate to a translational velocity of hydraulic cylinder 26, while a pressure differential between first and second chambers 52, 54 may relate to a force imparted by hydraulic cylinder 26 on the associated linkage structure of implement system 12. It should be noted that, although hydraulic cylinders 32 and 34 are not shown in FIG. 2, their structure and operation may be similar that described above with respect to hydraulic cylinder 26.

Left travel, right travel, and swing motors 42L, 42R, 43 (referring to FIG. 1), like hydraulic cylinder 26, may be driven by a fluid pressure differential. Specifically, each of these motors may include first and second chambers (not shown) located to either side of a pumping mechanism, such as an impeller, plunger, or series of pistons (not shown). When the first chamber is filled with pressurized fluid and the second chamber is drained of fluid, the pumping mechanism may be urged to move or rotate in a first direction. Conversely, when the first chamber is drained of fluid and the second chamber is filled with pressurized fluid, the pumping mechanism may be urged to move or rotate in an opposite direction. The flow rate of fluid into and out of the first and second chambers may determine a rotational velocity of the corresponding motor, while a pressure differential across the pumping mechanism may determine an output torque. It is contemplated that a displacement of left travel motor 42L, right travel motor 42R, and/or swing motor 43 may be variable, if desired, such that for a given flow rate and/or pressure of supplied fluid, a rotational speed and/or output torque of the motor may be adjusted.

As illustrated in FIG. 2, machine 10 may include a hydraulic system 56 having a plurality of fluid components that cooperate to move work tool 14 and machine 10 via hydraulic cylinder 26. In particular, hydraulic system 56 may include, among other things, a tool circuit 58 and a charge circuit 62. Tool circuit 58 may be a boom circuit associated with hydraulic cylinder 26. Charge circuit 62 may be selectively fluidly connected with tool circuit 58 to receive excess fluid from tool circuit 58 and/or to provide makeup fluid to tool circuit 58, as necessary. It is contemplated that additional and/or different configurations of circuits may be included within hydraulic system 56 such as, for example, a bucket (not shown) circuit associated with hydraulic cylinder 34 and swing motor 43; a stick circuit (not shown) associated with hydraulic cylinder 32, left travel motor 42L, and right travel motor 42R; or an independent circuit associated with each separate actuator (e.g., with each of hydraulic cylinders 32, 34, 26; left travel motor 42L; right travel motor 42R; and/or swing motor 43), if desired. In addition, in exemplary embodiments, one or more of the circuits of hydraulic system 56 may be meterless circuits.

In the disclosed embodiment, tool circuit 58 includes a plurality of interconnecting and cooperating fluid components that facilitate independent use and control of hydraulic cylinder 26. For example, tool circuit 58 may include a pump 66 that is fluidly connected to hydraulic cylinder 26 via a closed-loop formed by first and second pump passages 68, 70, a rod-end passage 72, and a head-end passage 74. To cause hydraulic cylinder 26 to extend, head-end passage 74 may be filled with fluid pressurized by pump 66 (via first or second pump passages 68, 70, depending on a rotational direction of pump 66), while rod-end passage 72 may be filled with fluid returning from hydraulic cylinder 26 (vie the other first or second pump passages 68, 70). In contrast, during a retracting operation, rod-end passage 72 may be filled with fluid pressurized by pump 66, while head-end passage 74 may be filled with fluid returning from hydraulic cylinder 26.

Pump 66 may be a variable displacement, overcenter-type pump. That is, pump 66 may be controlled to draw fluid from hydraulic cylinder 26 and discharge the fluid at a specified elevated pressure through a range of flow rates back to hydraulic cylinder 26 in two different directions. For this purpose, pump 66 may include a displacement controller, such as a swashplate and/or other like stroke-adjusting mechanism. The position of various components of the displacement controller may be electro-hydraulically and/or hydro-mechanically adjusted based on, among other things, a demand, a desired speed, a desired torque, and/or a load of hydraulic cylinder 26 to thereby change a displacement (e.g., a discharge rate and/or pressure) of pump 66. The displacement of pump 66 may be varied from a zero displacement position at which substantially no fluid is discharged from pump 66, to a maximum displacement position in a first direction at which fluid is discharged from pump 66 at a maximum rate and/or pressure into first pump passage 68. Likewise, the displacement of pump 66 may be varied from the zero displacement position to a maximum displacement position in a second direction at which fluid is discharged from pump 66 at a maximum rate and/or pressure into second pump passage 70. Pump 66 may be drivably connected to power source 18 of machine 10 by, for example, a countershaft, a belt, or in another suitable manner. Alternatively, pump 66 may be indirectly connected to power source 18 via a torque converter, a gear box, an electrical circuit, or in any other manner known in the art. It is contemplated that pump 66 may alternatively be a non-overcenter (i.e., unidirectional) pump, if desired.

Pump 66 may also be selectively operated as a motor. More specifically, when hydraulic cylinder 26 is operating in an overrunning condition, the fluid discharged from hydraulic cylinder 26 may have a pressure elevated higher than an output pressure of pump 66. In this situation, the elevated pressure of the actuator fluid directed back through pump 66 may function to drive pump 66 to rotate with or without assistance from power source 18. Under some circumstances, pump 66 may even be capable of imparting energy to power source 18, thereby improving an efficiency and/or capacity of power source 18.

Hydraulic system 56 may be provided with one or more load-holding valves 114 that are configured to maintain a position of hydraulic cylinder 26 when no movement thereof has been requested. Such load holding valves 114 may embody, for example, two-position, two-way, solenoid-controlled valves. Each load holding valve 114 may be moveable from a first position at which fluid may freely flow in either direction between the corresponding first or second pump passage 68, 70 and the corresponding rod- or head-end passage 72, 74, to a second position (shown in FIG. 2) at which fluid may flow only in one direction into the rod- or head-end passage 72, 74 based on a pressure differential across load holding valve 114. Load holding valves 114 may be spring-biased to their second positions (i.e., load holding valves 114 may normally be in the second positions). When loading holding valves 78 are in their second positions, fluid may be inhibited from leaving hydraulic cylinder 26 through load holding valves 114, thereby locking hydraulic cylinder 26 in a particular actuated position.

It will be appreciated by those of skill in the art that the respective rates of fluid flow into and out of first and second chambers 52, 54 of hydraulic cylinder 26 during extension and retraction may not be equal. That is, because of the location of rod portion 50A within second chamber 54, piston assembly 50 may have a reduced pressure area within second chamber 54, as compared with a pressure area within first chamber 52. Accordingly, during retraction of hydraulic cylinder 26, more fluid may be forced out of first chamber 52 than can be consumed by second chamber 54 and, during extension, more fluid may be consumed by first chamber 52 than is forced out of second chamber 54.

In order to accommodate the excess fluid discharged during retraction of hydraulic cylinder 26, tool circuit 58 may be provided with two relief valves 88 that are fluidly coupled with charge circuit 62 via a common passage 90. Relief valves 88 may be provided to allow fluid relief from hydraulic cylinder 26 into charge circuit 62 when a pressure of the fluid exceeds a set threshold of relief valves 88. In one embodiment, relief valves 88 may be set to operate at relatively high pressure levels in order to prevent damage to hydraulic system 56, for example at levels that may be reached only when hydraulic cylinder 26 reaches an end-of-stroke position and the flow from pumps 66 is nonzero, or during a failure condition of hydraulic system 56.

In order to accommodate the additional fluid required during extension of hydraulic cylinder 26, tool circuit 58 may be provided with a makeup valve 61 that is fluidly coupled with charge circuit 62 via common passage 90. Makeup valve 61 may be associated with first and second pump passages 68, 70, and pilot-operated to move between three-positions based on a pressure differential between first and second pump passages 68, 70. When makeup valve 61 is in the first position (middle position shown in FIG. 2 corresponding with a pressure balance between first and second pump passages 68, 70), fluid flow through makeup valve 61 may be inhibited. When makeup valve 61 is in the second position (lower position shown in FIG. 2 corresponding to low pressure within first pump passage 68), fluid flow from common passage 90 into first pump passage 68 may be allowed via a makeup passage 63. When makeup valve 61 is in the third position (upper position shown in FIG. 2 corresponding to low pressure within second pump passage 70), fluid flow from common passage 90 into second pump passage 70 may be allowed via a makeup passage 64.

A first pilot passage 67 may connect a pilot pressure signal from makeup passage 63 to an end of makeup valve 61 to urge makeup valve 61 toward the third position, while a second pilot passage 69 may connect a pilot pressure signal from makeup passage 64 to an opposing end of makeup valve 61 to urge makeup valve 61 toward the second position. When the pressure signal within first pilot passage 67 sufficiently exceeds the pressure signal within second pilot passage 69 (i.e., exceeds by an amount about equal to or greater than a centering spring bias of makeup valve 61), makeup valve 61 may move toward the third position. And when the pressure signal within second pilot passage 69 sufficiently exceeds the pressure signal within first pilot passage 67, makeup valve 61 may move toward the second position. First and second pilot passages 67, 69 may each include a fixed restrictive orifice 71 that helps to reduce pressure oscillations having a potential to cause instabilities in movement of makeup valve 61. Makeup valve 61 may be spring-centered toward the first position. That is, makeup valve 61 may normally be in the first position.

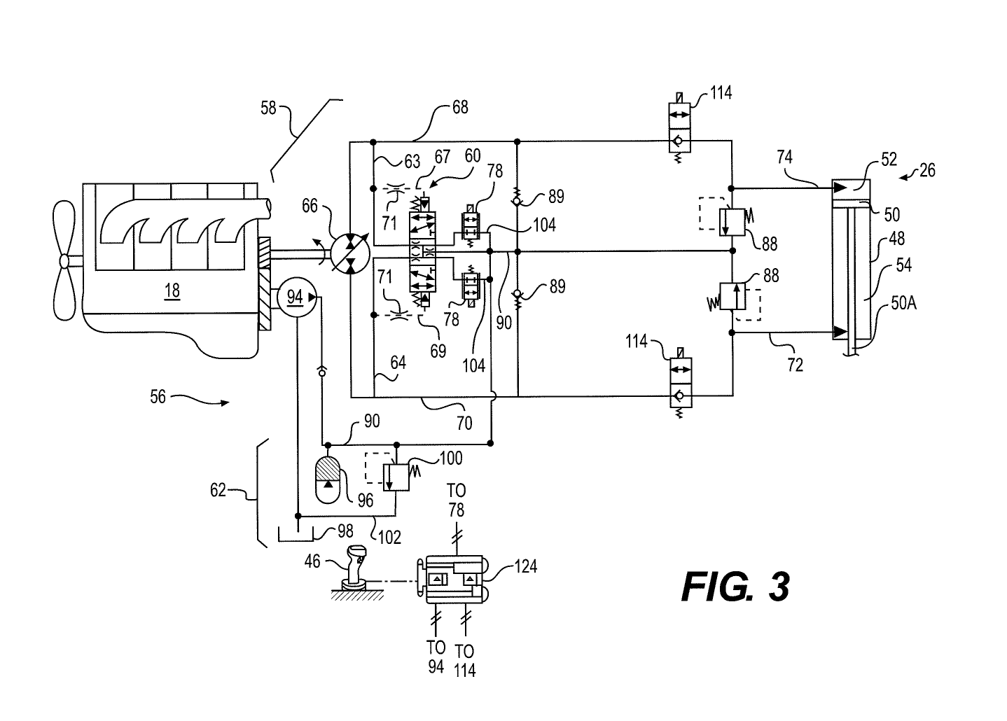

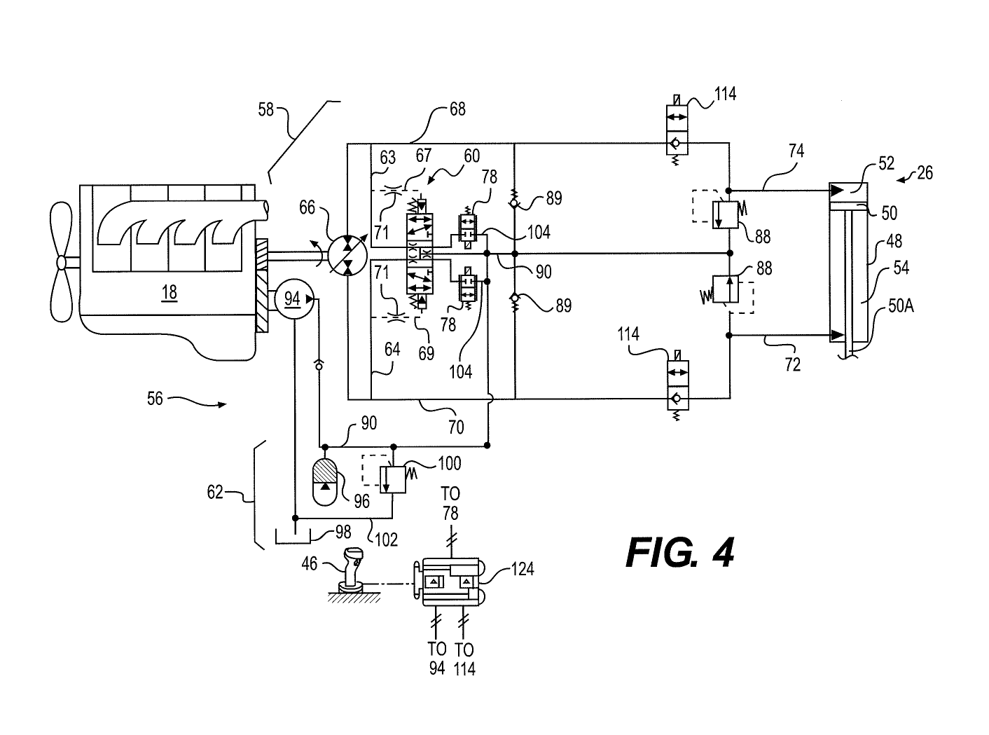

It should be noted that, when makeup valve 61 is in the first position, flow through makeup valve 61 may either be completely blocked(shown in FIG. 2) or only restricted to inhibit flow by a desired amount. That is, makeup valve 61 could include restrictive orifices (shown only in the embodiments of FIGS. 3 and 4) that block some or all fluid flow when makeup valve 61 is in the first position, if desired. The use of restrictive orifices may be helpful during situations where pump 66 does not return to a perfect zero displacement when commanded to neutral. Accordingly, any reference to the first position of makeup valve 61 as being a flow-inhibiting position is intended to include both a completely blocked condition and a condition wherein flow through makeup valve 61 is limited but still possible.

Charge circuit 62 may include at least one hydraulic source fluidly connected to common passage 90 described above. In the disclosed embodiment, charge circuit 62 has two sources, including a charge pump 94 and an accumulator 96, which are fluidly connected to common passage 90 in parallel to provide makeup fluid to tool circuit 58. Charge pump 94 may embody, for example, an engine-driven, fixed or variable displacement pump configured to draw fluid from a tank 98, pressurize the fluid, and discharge the fluid into common passage 90. Accumulator 96 may embody, for example, a compressed gas, membrane/spring, or bladder type of accumulator configured to accumulate pressurized fluid from and discharge pressurized fluid into common passage 90. Excess hydraulic fluid, either from charge pump 94 or from tool circuit 58 (i.e., from operation of pump 66 and/or hydraulic cylinder 26) may be directed into either accumulator 96, or into tank 98 by way of a charge relief valve 100 disposed in a return passage 102. Charge relief valve 100 may be movable from a flow-blocking position toward a flow-passing position as a result of elevated fluid pressures within common passage 90 and return passage 102.

One or more force modulation control valves 78 may be associated with tool circuit 58 (e.g., associated with one or both of first and second pump passages 68, 70) to help regulate a speed and/or force of work tool 14 imparted by hydraulic cylinder 26. It is contemplated, however, that force modulation control valve 78 could alternatively or additionally be associated with other hydraulic actuators (e.g., hydraulic cylinder 32, hydraulic cylinder 34, swing motor 43, left and/or right travel motors 42L, 42R) and/or other circuits of hydraulic system 56, if desired.

Each force modulation control valve 78 may be disposed between one of first and second pump passages 68, 70 and common passage 90, and selectively movable by solenoid force against a spring bias from a first position to a second position. When force modulation control valve 78 is in the first position (shown in FIG. 2), force modulation control valve 78 may function as a makeup valve. In particular, force modulation control valve 78, when in the first position, may be configured to selectively allow pressurized fluid from charge circuit 62 to enter the corresponding other of first or second pump passages 68, 70. When force modulation control valve 78 is in the first position, however, force modulation control valve 78 may prohibit fluid from passing in the opposite direction.

When force modulation control valve 78 is in the second position, force modulation control valve 78 may function as a bypass valve to selectively allow fluid pressurized by pump 66 to bypass hydraulic cylinder 26 and flow either to the inlet of pump 66 or into charge circuit 62, depending on a pressure differential. Force modulation control valve 78 may be movable to any position between the first and second positions. And, depending on the position of force modulation control valve 78, a different flow rate and/or pressure of fluid may bypass hydraulic actuator 26.

When high-pressure fluid from either of first or second pump passages 68, 70 bypasses hydraulic cylinder 26 via force modulation control valve 78 and flows directly into the other of first and second pump passages 68, 70 (or into charge circuit 62), a reduction in speed and/or force of hydraulic cylinder 26 may occur. In particular, because there may be little resistance to the flow of fluid bypassing hydraulic cylinder 26 when force modulation control valve is away from its first position, the pressure of the fluid within tool circuit 58 may remain relatively low. This low-pressure fluid may result in a reduced speed and/or force capacity of hydraulic cylinder 26 and a corresponding increased controllability over the movement of work tool 14. As force modulation control valve 78 nears its first position, a greater resistance may be placed on the flow of bypassing fluid within tool circuit 58, thereby causing a corresponding rise in the pressure of all fluid within tool circuit 58 and in the resulting speed and/or force capacity of hydraulic cylinder 26.

Accordingly, as an operator of machine 10 requests a greater force from hydraulic cylinder 26 (e.g., as the operator displaces interface device 46 by a greater distance), force modulation control valve 78 may be caused to move toward its first position by a greater amount. When force modulation control valve 78 is moved fully to the first position, substantially no fluid may be bypassing hydraulic cylinder 26 via force modulation control valve 78, such that full speed and/or force of hydraulic cylinder 26 may be available to the operator.

It should be noted that, when force modulation control valve 78 is fully in the first position, force modulation control valve 78 may no longer be restricting the flow of any fluid through tool circuit 58. Accordingly, any metering losses associated with force modulation control valve 78 may only be experienced when force modulation control valve 78 is metering (i.e., in a position other than the first position). The functionality provided by force modulation control valve 78 may result in greater control over hydraulic cylinder 26 and allow hydraulic cylinder 26 to stop when a load on work tool 14 increases beyond a particular level, thereby enabling the operator to accomplish delicate position control tasks.

It should be noted that, although force modulation control valve 78 is shown as a two-position, solenoid-operated, spool-type valve, it is contemplated that force modulation control valve 78 could have another form, if desired. For example, force modulation control valve 78 could only have bypass functionality, if desired, and embody a two-position, on/off, poppet-type valve. In this arrangement, one or more additional valves could be included within tool circuit 58 to provide the makeup functionality described above.

During operation of machine 10, the operator of machine 10 may utilize interface device 46 to provide a signal that identifies a desired movement of the various linear and/or rotary actuators to a controller 124. Based upon one or more signals, including the signal from interface device 46 and, for example, signals from various pressure sensors and/or position sensors (not shown) located throughout hydraulic system 56, controller 124 may command movement of the different valves and/or displacement changes of the different pumps and motors to advance a particular one or more of the linear and/or rotary actuators to a desired position in a desired manner (i.e., at a desired speed and/or with a desired force).

Controller 124 may embody a single microprocessor or multiple microprocessors that include components for controlling operations of hydraulic system 56 based on input from an operator of machine 10 and based on sensed or other known operational parameters. Numerous commercially available microprocessors can be configured to perform the functions of controller 124. It should be appreciated that controller 124 could readily be embodied in a general machine microprocessor capable of controlling numerous machine functions. Controller 124 may include a memory, a secondary storage device, a processor, and any other components for running an application. Various other circuits may be associated with controller 124 such as power supply circuitry, signal conditioning circuitry, solenoid driver circuitry, and other types of circuitry.

An alternative embodiment of hydraulic system 56 is illustrated in FIG. 3. Like the embodiment of FIG. 2, hydraulic system 56 of FIG. 3 my include a closed-loop tool circuit having first and second pump passages 68, 70 fluidly connecting pump 66 to rod- and head-end passages 72, 74 of hydraulic cylinder 26. Hydraulic system 56 of FIG. 3 may also include relief valves 88 and load holding valves 114, while also being fluidly connected to charge circuit 62 via common passage 90. However, in contrast the embodiment of FIG. 2, hydraulic system 56 of FIG. 3 may include additional makeup valves 89 and a makeup valve 60 that is different from makeup valve 61. Further, force modulation control valves 78 may be disposed at different positions.

Makeup valves 89 may each be check valves or another type of valve fluidly coupled between first and second pump passages 68, 70 and common passage 90, at a location between pump 66 and load holding valves 114. In this position, makeup valves 89 may be configured to block flow in a first direction and to permit flow only in a second direction. For example, makeup valves 89 may be configured to selectively allow pressurized fluid from charge circuit 62 to enter first and/or second pump passages 68, 70. Such valves may, however, prohibit fluid from passing in the opposite direction.

Makeup valve 60, like makeup valve 61, may be associated with first and second pump passages 68, 70 and movable from a neutral first position to an actuated second or third position by high-pressure fluid within one of pilot passages 67 or 69. When makeup valve 60 is in the first position (middle position shown in FIG. 3) fluid flow through makeup valve 60 may be inhibited (restricted, but still allowed in the embodiment of FIG. 3). When makeup valve 60 is in the second position (lower position shown in FIG. 3), fluid flow from common passage 90 into first pump passage 68 may be allowed via makeup passage 63. When makeup valve 60 is in the third position, (upper position shown in FIG. 3) fluid flow from common passage 90 into second pump passage 70 may be allowed. Makeup valve 60 may be spring-centered toward the first position.

Force modulation control valves 78, in the embodiment of FIG. 3, may be disposed within bypass passages 104 that connect ports of makeup valve 60 with common passage 90. Depending on the position of makeup valve 60, the movement of force modulation control valves 78 may control bypassing flows of fluid and corresponding speed and force of work tool 14 in a number of different ways.

For example, when makeup valve 60 is in its first position (i.e., when pressures between first and second pump passages 68, 70 are substantially balanced) and force modulation control valves 78 are in their first positions (combination shown in FIG. 3), fluid may flow from charge circuit 62 via common passage 90 into either of first or second pump passages 68, 70 by way of force modulation control valves 78 and/or makeup valve 60 (depending on pressure differentials between the three passages). In addition, fluid may flow from the higher pressure one of first and second pump passages 68, 70 into the lower pressure one of first and second pump passages 68, 70 via only makeup valve 60 at this time. These flows, however, may be restricted within makeup valve 60.

When makeup valve 60 is in its second position (i.e., when pressures within first pump passage 68 are substantially lower than pressures within second pump passage 70) and force modulation control valves 78 are in their first positions, makeup fluid from common passage 90 may be allowed only into first pump passage 68 and flow to or from second pump passage 70 through force modulation control valves 78 may be substantially blocked. Likewise, when makeup valve 60 is in its third position (i.e., when pressures within second pump passage 70 are substantially lower than pressures within first pump passage 68) and force modulation control valves 78 are in their first positions, makeup fluid from common passage 90 may be allowed only into second pump passage 70 and flow to or from first pump passage 68 through force modulation control valves 78 may be substantially blocked. In other words, these combinations of valve positions may result in little, if any, force modulation of hydraulic cylinder 26.

When makeup valve 60 is in its second position and force modulation control valve 78 associated with second pump passage 70 (i.e., the lower most force modulation control valve 78 shown in FIG. 3) is in its flow-passing position, first pump passage 68 may be fluidly connected with common passage 90 to receive makeup fluid and to second pump passage 70 to receive bypassing fluid. The connection with second pump passage 70, however, may be restricted to some degree. Similarly, when makeup valve 60 is in its third position and force modulation control valve 78 associated with first pump passage 68 (i.e., the upper most force modulation control valve 78 shown in FIG. 3) is in its flow-passing position, second pump passage 70 may be fluidly connected with common passage 90 to receive makeup fluid and to first pump passage 68 to receive bypassing fluid. The connection with first pump passage 68, however, may be restricted to some degree.

As described above, when high-pressure fluid from either of first or second pump passages 68, 70 bypasses hydraulic cylinder 26 and flows directly into the other of first and second pump passages 68, 70 via force modulation control valves 78, a reduction in speed and/or force of hydraulic cylinder 26 may occur. In particular, because there may be little resistance to the flow of fluid bypassing hydraulic cylinder 26 in these combinations of valve positions, the pressure of the fluid within tool circuit 58 may remain relatively low. This low-pressure fluid may result in a reduced speed and/or force capacity of hydraulic cylinder 26 and a corresponding increased controllability over the movement of work tool 14. As force modulation control valves 78 nears their first positions, a greater resistance may be placed on the flow of bypassing fluid within tool circuit 58, thereby causing a corresponding rise in the pressure of all fluid within tool circuit 58 and in the resulting speed and/or force capacity of hydraulic cylinder 26.

FIG. 4 illustrates an additional embodiment of hydraulic system 56. The embodiment of FIG. 4 may be similar to the embodiment of FIG. 3, with the exception of force modulation control valves 78. In particular, force modulation control valves 78 of FIG. 4, when in their first positions, may not provide any makeup functionality. That is, force modulation control valve 78 may completely block fluid flow when in their first positions. In this arrangement, all makeup fluid may occur via makeup valves 89.

### INDUSTRIAL APPLICABILITY

The disclosed hydraulic system may be applicable to any machine where improved hydraulic efficiency and control is desired. The disclosed hydraulic system may provide for improved efficiency through the use of meterless technology. The disclosed hydraulic system may provide for improved control through the use of force modulation. Operation of hydraulic system 56 will now be described.

During operation of machine 10, an operator located within station 20 may tilt interface device 46 in a particular direction by a particular amount and/or with a particular speed to command motion of work tool 14 in a desired direction, at a desired velocity, and/or with a desired force. One or more corresponding signals generated by interface device 46 may be provided to controller 124 indicative of the desired motion, along with machine performance information, for example sensor data such a pressure data, position data, speed data, pump or motor displacement data, and other data known in the art.

For example, in response to the signals from interface device 46 indicative of a desire to lift work tool 14 with an increasing velocity, and based on the machine performance information, controller 124 may generate control signals directed to the stroke-adjusting mechanism of pump 66 within tool circuit 58 and/or to one or both of force modulation control valves 78. These control signals may include a first control signal that causes pump 66 to increase its displacement and discharge pressurized fluid into first pump passage 68 at a greater rate. When fluid from pump 66 is directed into first chamber 52 via first pump and head-end passages 68, 74, return fluid from second chamber 54 of hydraulic cylinders 26 may flow back to pump 66 via rod-end and second pump passages 72, 70 in closed-loop manner. At this time, the pressure of fluid within first pump passage 68 may be greater than the pressure of fluid within second pump passage 70 and, accordingly, cause makeup valve 60 to move toward its third position.

At about this same time, a second control signal may be sent to force modulation control valve 78 associated with first pump passage 68, causing force modulation control valve 78 to move to a position corresponding to the displacement of interface device 46. For example, if interface device 46 is displaced by only a small amount, force modulation control valve 78 may be moved nearly or all the way to its flow-passing position, at which a large amount of fluid from first pump passage 68 may bypass hydraulic cylinder 26 and flow directly into second pump passage 70 via makeup valve 60. In this situation, hydraulic cylinder 26 may be extending relatively slowly and/or with relatively little force. The extension may continue until work tool 14 becomes more heavily loaded or engages an immovable mass, at which time work tool 14 may stop moving and all of the fluid from first pump passage 68 may be forced to bypass hydraulic cylinder 26 and flow directly into second pump passage 68 via force modulation control valve 78 and makeup valve 60.

If however, interface device 46 is displaced by a greater amount (e.g., moved further upon work tool movement stopping), force modulation control valve 78 associated with first pump passage 68 may be caused by controller 124 to move a greater amount towards its flow-blocking position, at which a lesser amount of fluid from first pump passage 68 may bypass hydraulic cylinder 26 and flow directly into second pump passage 70 via makeup valve 60. In this situation, hydraulic cylinder 26 may extend more quickly and/or with greater force, as more fluid will be directed into hydraulic cylinders 26. As the operator continues to displace interface device 46 by greater amounts, force modulation control valve 78 will eventually move all the way to its flow-blocking position, and hydraulic cylinder 26 will move with a maximum force and/or at a maximum speed. In this manner, the operator may be provided with force control over hydraulic cylinders 26. Force modulation of other actuators within hydraulic system 56 may be regulated in a similar manner.

To drive hydraulic cylinder 26 at an increasing speed in a retracting direction (e.g., to lower work tool 14), controller 124 may generate a first control signal that causes pump 66 of tool circuit 58 to increase its displacement in a reverse flow direction and discharge pressurized fluid into second pump passage 70 at a greater rate, while simultaneously generating a second control signal that causes force modulation control valve 78 associated with second pump passage 70 to move to a position corresponding to the displacement of interface device 46. When interface device 46 is displaced by only a small amount, force modulation control valve 78 may move nearly or all the way to its flow-passing position and, when interface device 46 is displaced by a greater amount, force modulation control valve 78 may move towards its flow-blocking position. The high-flow second position may result in a relatively lower extending speed and/or force of hydraulic cylinder 26, as compared with the more restricted first position. As described above, when fluid from pump 66 is directed into second chamber 54 of hydraulic cylinder 26, return fluid from first chamber 52 may flow back into pump 66 in closed-loop manner, thereby allowing hydraulic cylinder 26 to retract at a speed and/or at a force related to the displacement of pump 66 and the position of force modulation control valve 78.

In the disclosed hydraulic system, flows provided by pump 66 may be substantially unrestricted during modulation of hydraulic cylinder 26, such that significant energy is not unnecessarily wasted in the actuation process. Thus, embodiments of the disclosure may provide improved energy usage and conservation. In addition, the closed-loop operation of hydraulic system 56 may, in some applications, allow for a reduction or even complete elimination of metering valves for controlling fluid flow associated with the linear and rotary actuators. This reduction may result in a less complicated and/or less expensive system.

The disclosed hydraulic system may also provide for force modulation of hydraulic cylinder 26. In particular through pressure control facilitated by force modulation control valve 78, an operator of machine 10 may be provided with an additional and more controlled way in which the movement of work tool 14 may be manipulated. This control may provide for enhanced performance of machine 10.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a pump configured to draw low-pressure fluid from one of a first passage and a second passage, and discharge fluid at an elevated pressure into the other of the first and second passages;
an actuator coupled to the pump via the first and second passages;
a charge circuit;
a makeup valve movable by a pressure differential between the first and second passages to connect the charge circuit with a lower pressure one of the first and second passages;
a first force modulation control valve configured to selectively direct fluid from the pump through the makeup valve to the second passage to bypass the actuator; and
a second force modulation control valve configured to selectively direct fluid from the pump through the makeup valve to the first passage to bypass the actuator.

2. The hydraulic system of claim 1, wherein the makeup valve, first force modulation control valve, and second force modulation control valve are all fluidly connected to the charge circuit in parallel via a common passage.

3. The hydraulic system of claim 2, wherein:
the makeup valve and the first force modulation control valve are connected in parallel to the first passage; and
the makeup valve and the second force modulation control valve are connected in parallel to the second passage.

4. The hydraulic system of claim 3, wherein the makeup valve is movable between:
a first position at which flow through the makeup valve is inhibited;
a second position at which fluid is allowed to pass between the first passage and the charge circuit; and
a third position at which fluid is allowed to pass between the second passage and the charge circuit.

5. The hydraulic system of claim 4, wherein the makeup valve is a three-way spool valve.

6. The hydraulic system of claim 5, wherein the makeup valve is pilot operated to the second and third positions, and spring biased to the first position.

7. The hydraulic system of claim 4, wherein the first and second force modulation control valves are each two-position, two-way poppet valves.

8. The hydraulic system of claim 7, wherein the first and second force modulation control valves are solenoid operable between a first position at which makeup fluid is allowed to pass to the first or second passages, and a second position at which fluid is allowed to bypass the actuator.

9. The hydraulic system of claim 8, wherein the first and second force modulation control valves are spring-biased to the first position.

10. The hydraulic system of claim 8, further including at least one relief valve disposed in parallel with the makeup valve, the first force modulation control valve, and the second force modulation control valve.

11. The hydraulic system of claim 1, further including:
a first bypass passage disposed between the makeup valve and the charge circuit; and
a second bypass passage disposed between the makeup valve and the charge circuit;
wherein:
the first force modulation control valve is located within the first bypass passage; and
the second force modulation control valve is located within the second bypass passage.

12. The hydraulic system of claim 11, further including a common passage directly connecting the makeup valve with the charge circuit

13. The hydraulic system of claim 12, wherein the makeup valve is movable from a first position at which fluid is allowed to flow between the charge circuit, the first passage, and the second passage via the common passage; to a first position at which fluid from the first passage is allowed to flow through the first bypass passage and first force modulation control valve to the second passage; and to a second position at which fluid from the second passage is allowed to flow through the second bypass passage and second force modulation control valve to the first passage.

14. The hydraulic system of claim 13, wherein, when the makeup valve is in the first position, flow between the first passage, second passage, and common passage is allowed, but restricted.

15. The hydraulic system of claim 13, wherein the makeup valve is pilot operated to the first or second positions, and spring biased to the first position.

16. The hydraulic system of claim 15, wherein the first and second force modulation control valves are two-position, two way valve.

17. The hydraulic system of claim 15, wherein the first and second force modulation control valves are movable from a flow-blocking position against a spring bias toward a flow-passing position

18. The hydraulic system of claim 15, wherein the first and second force modulation control valves are movable from a makeup position against a spring bias toward a flow-passing position.

19. The hydraulic system of claim 13, further including at least one relief valve connected to the common passage in parallel with the makeup valve, first force modulation control valve, and the second force modulation control valve.

20. The hydraulic system of claim 19, wherein:
the makeup valve is a primary makeup valve; and
the hydraulic system further includes at least one secondary makeup valve disposed in parallel with the at least one relief valve, the makeup valve, first force modulation control valve, and the second force modulation control valve.

21. A method of operating a hydraulic system, comprising:
drawing fluid from one of a first passage and a second passage fluidly connected to an actuator, pressurizing the fluid with a pump, and directing the pressurized fluid into the other of the first and second passages to move the actuator;
selectively directing makeup fluid from a charge circuit through a makeup valve into a lower-pressure one of the first and second passages;
selectively directing fluid from the pump through the makeup valve to the second passage to bypass the actuator; and
selectively directing fluid from the pump through the makeup valve to the first passage to bypass the actuator.

22. The method of claim 21, wherein:
selectively directing fluid from the pump through the makeup valve to the first or second passages to bypass the actuator includes directing the fluid through first and second force modulation control valves, respectively; and
the method further includes directing makeup fluid from the charge circuit through first or second force modulation control valves to the first or second passage.
